(19) United States
(12) Patent Application Publication
(10) Pub. No.: US 2009/0309427 A1
(43) Pub. Date: Dec. 17, 2009

(54) PRIMARY PART FOR A LINEAR ELECTRIC MOTOR

(75) Inventor: Michael Menhart, Igling (DE)

Correspondence Address: HENRY M FEIEREISEN, LLC;HENRY M FEIEREISEN, 708 THIRD AVENUE, SUITE 1501, NEW YORK, NY, 10017, US

(73) Assignee: Siemens Aktiengesellschaft, Munchen (DE)

(21) Appl. No.: 12/307,338

(22) PCT Filed: May 4, 2007
(86) PCT No.: PCT/EP2007/054355

§ 371 Date: Jan. 2, 2009

(30) Foreign Application Priority Data
Jul. 3, 2006 (DE) 10 2006 030 611.2

(51) Int. Cl. H02K 41/02

(52) U.S. Cl. 310/12.14

(57) ABSTRACT

The invention relates to a primary part (1) for an electric linear motor comprising motor windings, which are embedded in a casting compound, and a housing (2), which surrounds the primary part (1), wherein the housing (2) comprises an insertion opening (3) for receiving a connection module (10), wherein the connection module (10) has contact elements (11, 12), which are provided for the connection of the motor winding and the connection of at least one feed cable.

The invention relates to a primary part for a linear electric motor having motor windings which are encapsulated in encapsulation compound, and having a housing which surrounds the primary part, and to a connecting module for a primary part, and to a linear motor.

Linear motors have a primary part and a secondary part. In particular, the primary part is opposite the secondary part. By way of example, the secondary part has permanent magnets or windings through which current can flow. The primary part is provided for electric current to flow through it and has a series of motor windings which are supplied with electrical power from the outside via one or more supply cables.

Nowadays, it is generally normal practice to encapsulate the primary parts of linear motors with insulating, curing encapsulation compound, in order to prevent creepage currents and relative movements of the motor windings with respect to one another. However, this results in the disadvantage that, once the encapsulation compound has cured, the connections of the supply cable are also encapsulated, and are therefore no longer accessible. In the event of damage to the supply cable, which can easily occur in particular when the primary part is used as a moving part, the entire primary part is therefore unusable.

This problem can be avoided by fitting a so-called terminal box. The terminal box is an additional connecting box, which is mounted on the housing outside the primary part and into which the motor windings that are passed out of the primary part are inserted and are fixed on a terminal strip. The supply cable or cables for the electrical power supply are likewise inserted into the terminal box, and are connected via the terminal strip to the motor winding lines.

DE 199 20 700 A1 discloses a primary part for a linear motor, in which the connecting elements for the supply cables are embedded in the encapsulation compound, with the contact parts for fitting the supply cables being exposed on the outside. This has the disadvantage that the manufacture of a primary part and/or of the connecting area such as this is complex. The manufacturing process element for the connecting area is part of the entire manufacturing process for the primary part, that is to say it is dependent on various previous process steps. Furthermore, different negative encapsulation molds and manufacturing tools are required, corresponding to the various motor types.

The object of the present invention is to provide a primary part for a linear motor, which ensures that the connection for the supply cables is reliable and is optimized for manufacture. In addition, the primary part should be compact and it should be possible to produce it easily.

This object is achieved by the features of patent claims 1, 9 and 10. Advantageous developments are specified in the dependent claims.

According to the invention, the primary part has a housing with an insertion opening for holding a connecting module, with the connecting module having one or more contact elements for connection of the motor windings to at least one supply cable. The housing for the primary part may be formed from one or more parts.

The connecting module is a compact component which is introduced into the housing interior of the primary part in the area of the motor windings to be connected, for example by being pushed in or plugged in. The connecting module can also be pressed in. The connecting module can additionally be adhesively bonded to the housing of the primary part or is also encapsulated by additional encapsulation of the entire primary part. It is likewise possible for the connecting module to be screwed to the housing of the primary part, or to be clamped or clipped to the housing.

Before the connecting module is introduced into the insertion opening, which may also be in the form of an insertion slot, in the housing of the primary part, the contact elements for the connecting module are connected to the motor windings. The motor windings are therefore connected to the contact elements outside the primary part, thus considerably simplifying the assembly process. For this purpose, the end areas of the motor winding or motor windings are of such a length that connection is possible outside the primary part. The end areas of the motor windings are electrically insulated from one another, so that it is possible to insert the connecting module and the lengthened ends of the motor windings into the housing of the primary part without any problems. The connecting module, to which the motor windings are now connected, is then inserted into the primary part. The supply cables are then connected from the outside to the connecting module of the primary part. This has the advantage that, if the supply cable is damaged, it can easily be replaced, and the primary part can be reused.

The connecting module is generally arranged in the housing interior of the primary part. The supply cables are connected via a front face of the connecting module, which is externally accessible and is therefore not located in the housing of the primary part.

The connecting module is first of all manufactured separately, that is to say independently of the actual primary part, and is joined to the primary part after appropriate functional and quality testing. This has the advantage that the connecting module can be manufactured independently of the manufacture of the primary part.

The insertion opening is advantageously arranged on one end face of the housing of the primary part. In particular, the insertion slot is arranged on an end face of the primary part or of the housing which is in the direction of travel of the linear motor, thus resulting in the supply cables being fitted in the simplest and most reliable manner.

The connecting module preferably has a stop which limits the insertion process of the connecting module into the insertion opening in the housing. The stop is located on the front face of the connecting module, such that the stop ends in an interlocking manner with the housing once the connecting module has been inserted. For example, the stop is in the form of a frame or rim.

The contact elements are preferably in the form of connecting bolts, in particular threaded bolts, or contact rings, and are integrated in the connecting module or are arranged in an interlocking manner on the connecting module. If the contact elements are in the form of contact rings, the motor windings are connected via cable lugs and screws, with a nut being held by means of an interlock, such that it cannot rotate, in pockets in the injection-molded connecting module. The contact elements may also be in the form of a threaded rod, a sleeve with an internal thread, a plug, plug pin or a socket.

One contact element is provided for the connection of one motor winding to a respective supply cable. If the primary part, for example, has a plurality of phases (for example three phases u, v, w of a three-phase power supply system) and a plurality of windings (for example three windings for each phase), then windings of one phase can be connected in parallel or in series. The three windings of one phase can now be connected to a common supply cable. A supply cable can likewise be provided for the common connection of the various phases, by the supply cable itself having a plurality of different phases.

A plurality of contact elements of the connecting module can also be connected to one another by means of one or more bridge circuits, by means of which the desired circuit arrangement, such as a star or delta circuit, is provided. Three contact elements can be connected in parallel by means of bridge circuits, such that the desired circuit already exists when the supply cables are connected.

The contact elements, in particular the connecting bolts, are preferably arranged on the connecting module such that they cannot rotate. This allows the motor windings and the supply line to be fitted reliably and easily.

The connecting module is advantageously in the form of a plastic injection-molded part. By way of example, a temperature-resistant plastic is envisaged as the plastic. All available plastics which comply with the appropriate requirements for electrical insulation, mechanical strength, thermal and chemical resistance may be used as the plastic material.

The contact elements are held securely in the injection-molded connecting module and are insulated from one another by virtue of the electrical characteristics of plastic. Furthermore, injection-molded parts can be produced easily and at low cost. The contact elements are either inserted into the appropriate encapsulation mold, and are extrusion coated, during production of the connecting module, or are inserted therein after production of the injection-molded part.

The connecting module particularly advantageously has further contact elements for the connection of sensors, in particular temperature sensors. By way of example, the temperature sensors are used to monitor the motor temperature.

All the contact elements which are required for connections of the linear motor are thus arranged in one component, the connecting module, thus resulting in a compact component. Furthermore, no special tools are required for manufacture, since only the appropriate encapsulation mold is required. Since the manufacture of the connecting module is initially decoupled from the manufacture of the primary part, the connecting module can be tested separately for functionality and quality, and is joined to the primary part only if it does not have any faults. In the event of a fault report, only the connecting module then needs to be replaced and not the entire primary part. There is likewise no need for a terminal box on the linear motor.

Further features and details of the invention will be explained in more detail in conjunction with the attached drawings and with reference to exemplary embodiments in the following description. In this case, features and relationships which are described in individual variants can in principle be transferred to all the exemplary embodiments. In the drawings:

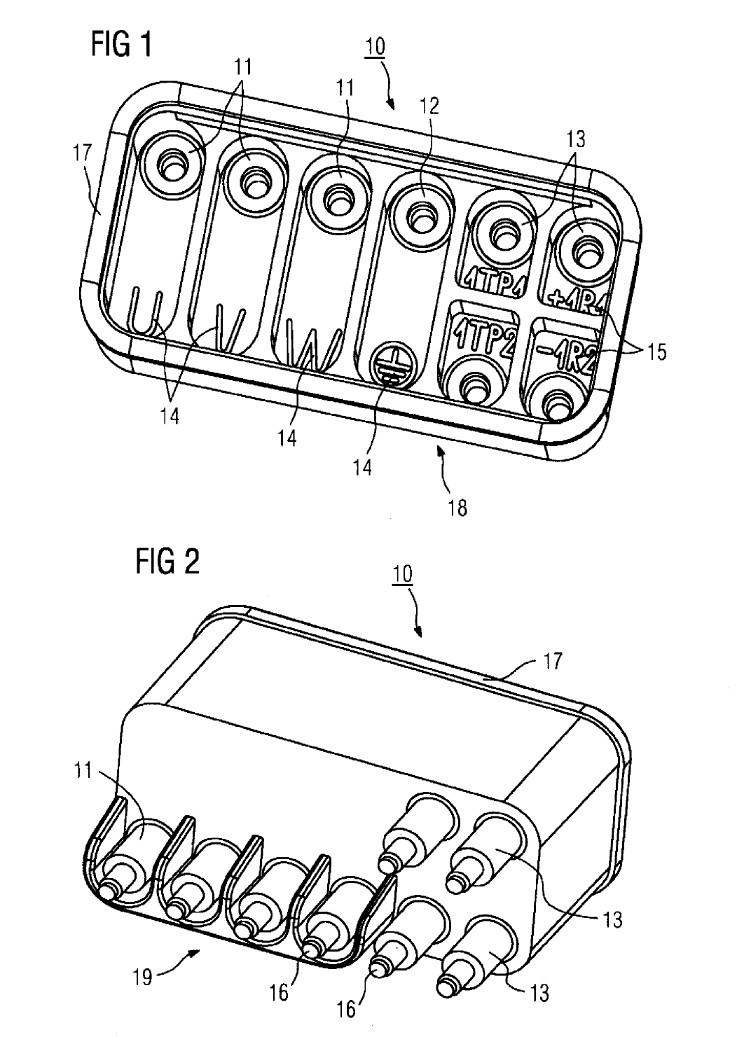

FIG. 1 shows a first embodiment of a connecting module, viewed from the front;

FIG. 2 shows the connecting module from FIG. 1, viewed from the rear;

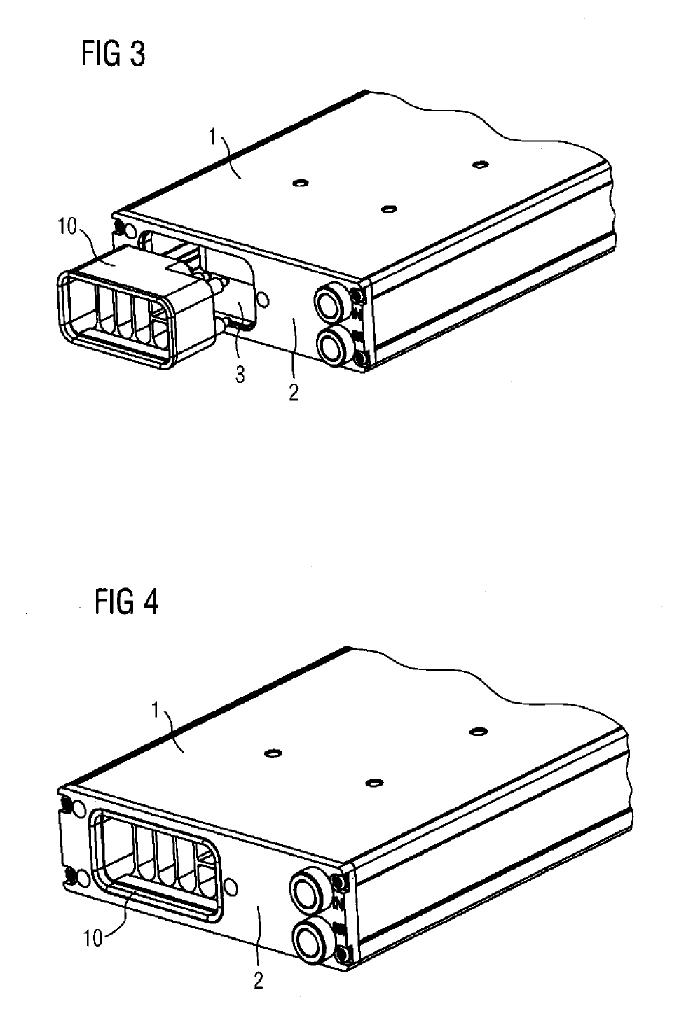

FIG. 3 shows the connecting module from FIG. 1 and a corresponding primary part;

FIG. 4 shows the connecting module from FIG. 1 arranged on a primary part;

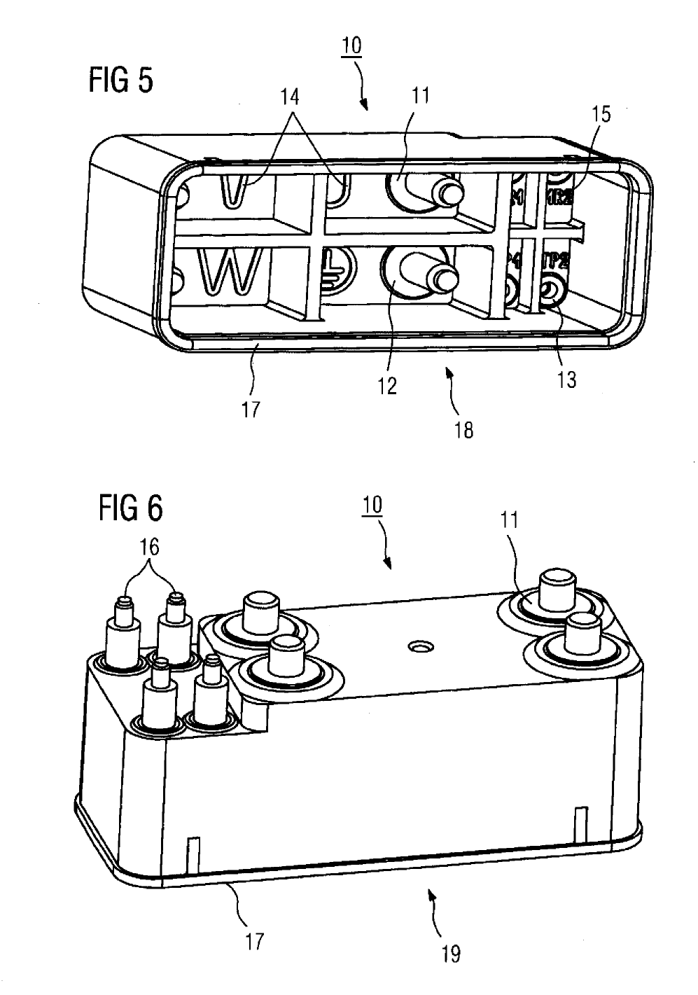

FIG. 5 shows a second embodiment of a connecting module, viewed from the front;

FIG. 6 shows the connecting module from FIG. 5, viewed from the rear;

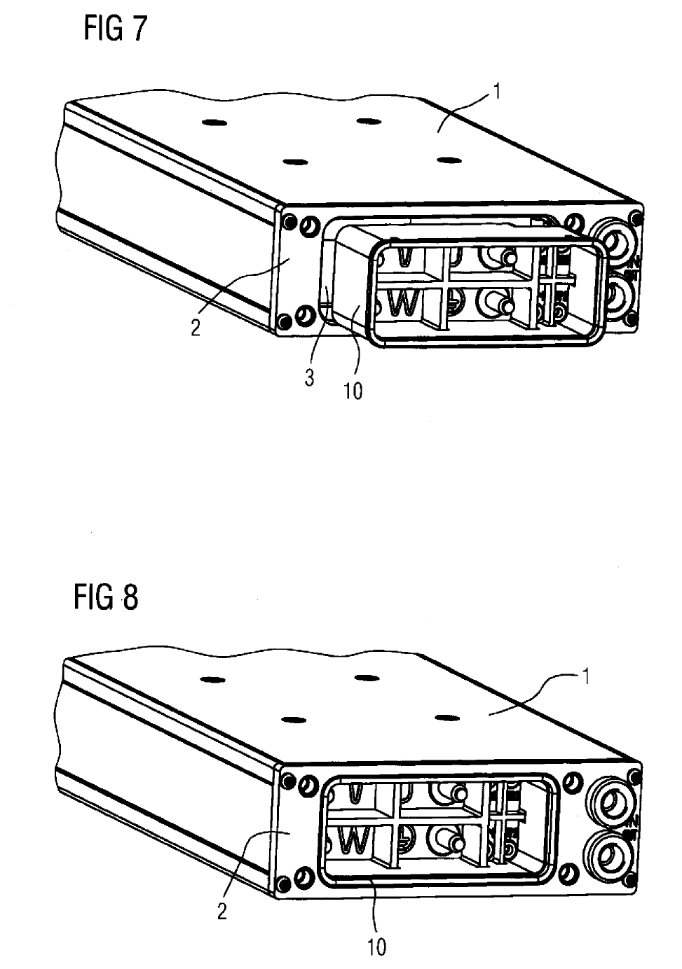

FIG. 7 shows the connecting module from FIG. 5 and a corresponding primary part; and

FIG. 8 shows the connecting module from FIG. 1 arranged on a primary part.

FIG. 1 shows a first embodiment of a connecting module 10, viewed from the front. The connecting module 10 has the contact elements 11 to 13. Each contact element 11 to 13 has an associated marking 14 (u, v, w, ground sign) or 15 (1TP1, 1TP2, +1R1, −1R2) which indicates how the contact elements should be connected. The contact elements 11 are used for the connection of the motor windings. In the present case, these are the three phases u, v, w of a three-phase AC power supply system.

Further contact elements may be provided, for example when the primary part has a plurality of motor windings for each phase. If, for example, the primary part has three motor windings for each phase u, v, w, then there are 9 contact elements.

The contact element 12 is intended for the connection of the ground cable, and the contact elements 13 are intended for sensor lines, for example for temperature sensors. The connecting module 10 is in the form of a plastic injection-molded part. The markings 14 and 15 can thus be formed in a simple manner by structuring of the injection-molding compound or by appropriate configuration of the encapsulation mold. Furthermore, the connecting module 10 has a stop 17, which is located on the front face 18 of the connecting module 10. The stop 17, which is in the form of a circumferential projecting frame or rim, has a larger circumference than the rest of the connecting module 10. If the connecting module 10 is inserted into a primary part, which is not shown, then the connecting module 10 can be inserted into the primary part until it reaches the stop 17. The stop 17 forms a limit, as a result of which the connecting module cannot be inserted indefinitely into the primary part and, where possible, is introduced irretrievably into the primary part. The stop 17 then rests flat and/or in an interlocking manner from the outside on a housing, which is not shown, of the primary part. The stop 17 in this case need not be in the form of a completely circumferential rim, but may also extend only over subareas of the connecting module 10.

FIG. 2 shows the connecting module 10 from FIG. 1, viewed from the rear. The contact elements 11, 12 and 13 are in the form of connecting bolts 16 and are integrated in the connecting module 10 or are arranged in an interlocking manner on the connecting module 10. The contact elements 11, 12, 13 may also be in the form of a threaded rod, sleeve with an internal thread, plug, plug pin or socket. The connecting bolt 16 are arranged on the connecting module 10 such that they cannot rotate. This allows the motor windings, which are not shown, to be fitted easily and securely to the rear face 19, which is illustrated in FIG. 2, of the connecting module 10, and the supply lines, which are not shown, to the front face 18, which is shown in FIG. 1.

FIG. 3 shows the connecting module 10 from FIG. 1 and FIG. 2, and a corresponding primary part 1. The connecting module 10 is a compact component which is introduced, for example pushed, plugged or pressed into the insertion opening 3 in the housing 2 in the area of the motor windings to be connected. The housing 2 is formed from a plurality of parts. Before the connecting module 10 is inserted into the insertion opening 3 in the primary part 1, the motor windings, which are not shown, are connected. In addition, the connecting module 10 may be adhesively bonded to the housing 2 of the primary part 1, or is then additionally encapsulated, by additional external encapsulation of the entire primary part 1. Finally, supply cables which are not shown are connected from the outside to the connecting module 10, and are used to supply electrical power for the motor winding, which is not shown.

FIG. 4 shows the connecting module 10 from FIG. 1 and FIG. 2, arranged in the primary part 1. The motor windings (not shown), inter alia, are accommodated in the housing 2 of the primary part 1. To this extent, the linear motor or the primary part 1 corresponds to a conventional linear motor whose design is generally known and will not be explained in detail here.

FIG. 5 shows a second embodiment of a connecting module 10 viewed from the front. In comparison to the first embodiment shown in FIGS. 1 to 4, the contact elements are arranged in an alternative manner. The connecting module 10 has the contact elements 11 to 13. Each contact element 11 to 13 has an associated marking 14 (u, v, w, ground sign) and 15 (1TP1, 1TP2, +1R1, −1R2), which indicates how the contact elements should be connected. The contact elements 11 are used for connection of the motor windings. In the present case, these are the three phases u, v, w of a three-phase AC power supply system. The contact element 12 is intended for the connection of the ground cable, and the contact elements 13 are intended for sensor lines for temperature sensors. The connecting module 10 is in the form of a plastic injection-molded part. The markings 14 and 15 can thus be formed in a simple manner by structuring of the injection-molding compound or by appropriate configuration of the encapsulation mold. Furthermore, the connecting module 10 has a stop 17 which, for example, is in the form of a projecting frame or rim, which is located on the front face of the connecting module 10.

FIG. 6 shows the connecting module 10 from FIG. 5, viewed from the rear. The contact elements 11, 12 and 13 are in the form of contact bolts 16 and are integrated in the connecting module 10, or are arranged in an interlocking manner on the connecting module 10. The contact elements 11, 12, 13 may also be in the form of a threaded rod, sleeve with an internal thread, plug or socket. The connecting bolts 16 are arranged on the connecting module 10 such that they cannot rotate. This allows the motor windings, which are not shown, to be fitted securely and more easily to that side of the connecting module 10 which is illustrated in FIG. 2, and the supply lines, which are not shown, to be fitted to the side shown in FIG. 1. The connecting module 10 is in the form of a plastic injection-molded part.

FIG. 7 shows the connecting module 10 from FIG. 5 and FIG. 6, and a corresponding primary part 1. The connecting module 10 is a compact component which is introduced, for example pushed into the insertion opening 3 in the primary part 1, in the area of the motor windings to be connected.

In addition, the connecting module 10 can be adhesively bonded to the housing 2 of the primary part 1 or is then also encapsulated with it, by means of additional external encapsulation of the entire primary part 1.

FIG. 8 shows the connecting module 10 from FIG. 5 and FIG. 6, arranged in the primary part 1. The motor windings (not shown), inter alia, are accommodated in the housing 2 of the primary part 1. To this extent, the linear motor or the primary part 1 corresponds to a conventional linear motor, whose design is generally known and will not be explained in detail here.

1.-10. (canceled)

11. A primary part for a linear electric motor having motor windings which are encapsulated in encapsulation compound, said primary part comprising:
a housing having an insertion opening; and
a connecting module received in the insertion opening and having contact elements for connection of the motor windings and connection of at least one supply cable.

12. The primary part of claim 11, wherein the insertion opening is arranged on an end face of the housing.

13. The primary part of claim 11, wherein the connecting module has a stop to limit insertion of the connecting module into the insertion opening of the housing.

14. The primary part of claim 11, wherein the contact elements are integrated in the connecting module.

15. The primary part of claim 11, wherein the contact elements are arranged in an interlocking manner on the connecting module.

16. The primary part of claim 11, wherein the contact elements are configured in the form of connecting bolts or contact rings.

17. The primary part of claim 11, wherein the contact elements are arranged such that as to be constraint against rotation.

18. The primary part of claim 11, wherein the connecting module is constructed in the form of a plastic injection-molded part.

19. The primary part of claim 11, wherein the connecting module has further contact elements for connection of a line of a sensor.

20. The primary part of claim 19, wherein the sensor is a temperature sensor.

21. A connecting module for a primary part, said connecting module received in an insertion opening of a housing of the primary part and having contact elements for connection of motor windings, which are encapsulated in encapsulation compound, and connection of at least one supply cable.

22. A liner motor, comprising:
a motor winding encapsulated in an encapsulation compound;
a primary part having a housing provided with an insertion opening; and
a connecting module received in the insertion opening and having contact elements for connection of the motor winding and connection of at least one supply cable.
